(19) United States
(12) Patent Application Publication
(10) Pub. No.: US 2013/0249755 A1
(43) Pub. Date: Sep. 26, 2013

(54) ELECTROMAGNETIC WAVE POLARIZER SCREEN

(71) Applicants: Francisco Javier Vazquez Sanchez, Madrid (ES); Robert Pearson, Rushmoor (GB)

(72) Inventors: Francisco Javier Vazquez Sanchez, Madrid (ES); Robert Pearson, Rushmoor (GB)

(73) Assignee: COBHAM CTS LTD, Surrey (GB)

(21) Appl. No.: 13/992,628

(22) PCT Filed: Dec. 2, 2011
(86) PCT No.: PCT/EP2011/071602

§ 371 Date: Jun. 7, 2013

(30) Foreign Application Priority Data
Dec. 22, 2010 (EP) 10196459.1

(51) Int. Cl. H01Q 15/24

(52) U.S. Cl. CPC H01Q 15/244
USPC 343/756; 343/911 R

(57) ABSTRACT

A polarizer screen for a satellite communications terminal, comprising a plurality of layers separated by dielectric material, each layer having a grid of parallel metal strips and a periodic distribution of interleaved metal dipoles, wherein a first set of dipoles is arranged to be perpendicular to the metal strips and a second set of dipoles is arranged to be parallel to the metal strips such that any linearly polarized electromagnetic waves that pass through the screen are converted into orthogonal circular polarization in different frequency bands.

The present invention relates to an electromagnetic wave polarizer screen and, more specifically, an electromagnetic wave polarizer screen for converting a single linear polarization into orthogonal circular polarizations in different frequency bands.

Radio services, such as communication, navigation and radar, are often delivered using circularly polarized (CP) electromagnetic waves. CP waves allow any relative rotational alignment between receive and transmit antennas, which is a significant advantage for portable equipment. Circularly polarized energy propagates in one of two states, either left-hand CP (LHCP) or right-hand CP (RHCP), which can be modulated with independent data.

In the field of satellite radio communications, the use of circular polarization is standard in the X and Ka frequency bands. Opposite hands of circular polarization are generally used for the up- and down-link frequencies, for example LHCP for up-link and RHCP for down-link. To support this, antennas are often provided with components to enable generation of CP signals.

Previously, CP signals have been generated by combining two orthogonal linearly polarized (LP) waves with the same amplitude and with a 90° phase difference between them. However, a problem with this arrangement is that the antenna must provide dual orthogonal linear polarizations even if only one hand of CP is needed. Furthermore, the two LP radiated beams provided by the antenna must be perfectly balanced (with equal gain and phasing) and a very good antenna match is essential to ensure good CP cross polar discrimination.

Alternatively, a multi-layer assembly known as a screen polarizer can be placed in front of the antenna aperture to generate CP. With this arrangement, as the LP wave launched by the antenna goes through the polarizing screen it is converted into CP and radiated into space. Only a single LP wave needs to be generated by the antenna, which avoids any problems associated with imbalance between the polarizations and input match. A single LP wave is also much simpler to produce than dual orthogonal LP waves, in particular in the case of printed flat plate antennas.

Modern day satellite communications require that orthogonal CPs are used in the up- and down-link frequency bands. For instance, for a Ka band satellite radio link it might be desirable to obtain LHCP for Rx bandwidth (20.2-21.2 GHz) and RHCP for Tx bandwidth (30-31 GHz).

A problem with existing arrangements that use a conventional screen polarizer is that they can only provide the same (non-orthogonal) hand of CP in each bandwidth.

According to the present invention there is provided screen for a satellite communications terminal, comprising a plurality of layers separated by dielectric material, each layer having a grid of parallel metal strips and a periodic distribution of interleaved metal dipoles, wherein a first set of dipoles is arranged to be perpendicular to the metal strips and a second set of dipoles is arranged to be parallel to the metal strips, wherein an effective resonance frequency of the parallel metal strips and interleaved metal dipoles is approximately the same in a direction parallel to the metal strips and in a direction perpendicular to the metal strips such that linearly polarized electromagnetic waves in different frequency bands either side of the resonance frequency that pass through the screen are converted into orthogonal circular polarization states.

The present invention consists of a multi-layer printed circuit board (PCB) having each layer printed with resonant metal strips and dipoles, the layers being separated by foam or any other low dielectric constant material or composite to form a screen polarizer structure. The present invention is designed to be used in combination with an antenna that generates a single linear polarization (LP) over a broad band and can transmit or receive orthogonal circular polarization (CP) energy in two separate sub-bands.

The polarizer screen is arranged to cover the linearly polarized radiating aperture such that any energy propagating through the structure will be converted into orthogonal circular polarizations in different sub-bands on the other side. The high purity circular polarization obtained should be LHCP (or RHCP) in one frequency band (typically 10-20% wide) and RHCP (or LHCP) (typically 10% wide) in a second higher frequency band suitable for the application. Typically, both the antenna aperture and the multilayer PCB forming the screen polarizer are planar but curved shapes (i.e. cylindrical or spherical) are also possible.

Preferably, the first set of metal dipoles are arranged to overlap and merge with the metal strips and, preferably, each of the metal dipoles form an T shape.

Preferably, the layers comprise polyamide, polyester or PTFE based substrates, the PTFE substrates ideally comprising glass or ceramic, and the layers preferably each having a thickness between about 0.025 and 0.125 mm.

Preferably, the dielectric spacer separating the layers is formed as a composite honeycomb structure.

Preferably, the polarizer screen of the present invention further comprises a conventional polarizer screen that converts linearly polarized waves into the same hand of circular polarization for both frequency bands, the polarizer screen arranged to be positioned behind the conventional polarizer screen, in use, such that incident electromagnetic waves propagate through the conventional polarizer screen and then the polarizer screen before reaching free space generating a linearly polarized wave at each frequency band, where the linear polarization of one band is orthogonal to the linear polarization generated at the other band. The conventional polarizer screen, preferably, comprises a conventional wideband polarizer.

According to the present invention there is also provided a dual band antenna, comprising a single linearly polarized radiating aperture covered by a polarizer screen, as described above, arranged to radiate a single circular polarization in each band where the hand of circular polarization in one frequency band is orthogonal to the polarisation of the other frequency band.

According to the present invention there is also provided a dual band antenna, comprising a single linearly polarized radiating aperture covered by a polarizer screen, as described above, arranged to radiate a single linear polarization in each band where the direction of polarization in one frequency band is orthogonal to the polarisation of the other frequency band.

Each of the above-described antennas may further comprise a radiating aperture arranged to radiate at a third separate band of frequency that is sufficiently low that the polarizer screen does not alter the radiated wave.

According to the present invention there is also provided a communications terminal with separate frequency sub-bands for receiving and transmitting circularly polarized radio signals, where the hand of polarization in the each sub-band is orthogonal, the terminal comprising a low noise amplifier and power amplifier connected to a diplexer filter which is connected to a single port of the first antenna described above.

According to the present invention there is also provided a communications terminal with separate frequency sub-bands for receiving and transmitting linearly polarized radio signals, where the direction of polarization in the each sub-band is orthogonal, the terminal comprising a low noise amplifier and power amplifier connected to a diplexer filter which is connected to a single port of the second antenna described above.

Each of the above-described communications terminals may each further comprise an aperture arranged to radiate a third separate band of frequency that is low relative to the two orthogonally polarized sub-bands.

An example of the present invention will now be described, with reference to the accompanying figures, in which:

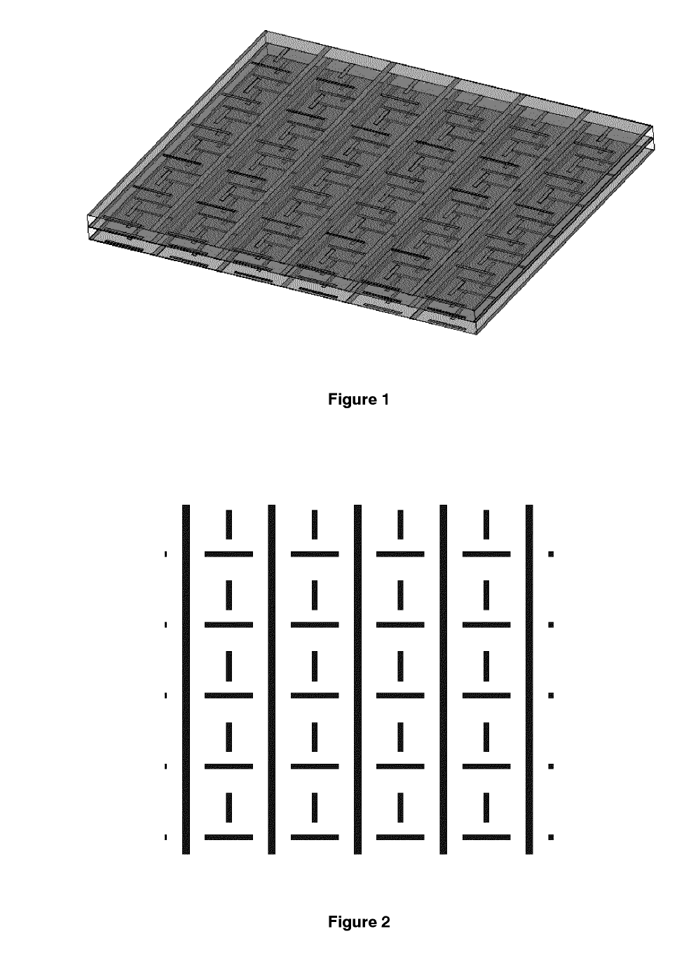

FIG. 1 shows a polarizer screen according to the present invention;

FIG. 2 shows a metal prints layer of a polarizer screen having a grid of strips and “parallel and perpendicular” dipoles;

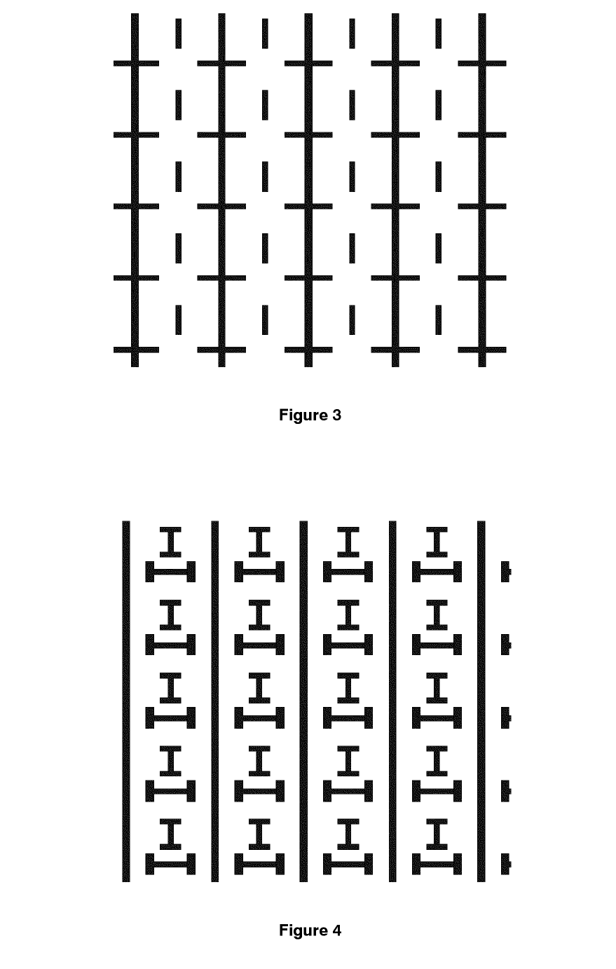

FIG. 3 shows a metal prints layer of a polarizer screen having a grid of strips and “crossed” dipoles;

FIG. 4 shows a metal prints layer of a polarizer screen having a grid of strips and “I”-shaped dipoles in a parallel and perpendicular arrangement; and

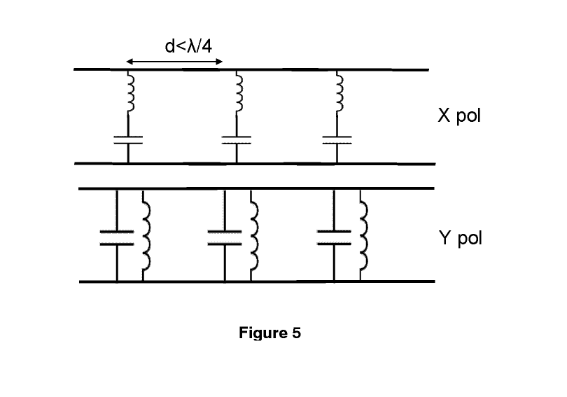

FIG. 5 shows an equivalent circuit of the dual band orthogonal polarizer.

With reference to FIG. 1, the present invention comprises a multi-layer structure comprising a plurality of thin dielectric layers, such as printed circuit boards (PCB). The layers should exhibit low dielectric losses (typical tan loss <0.005) at the relevant frequencies and may comprise, for example, polyamide, polyester or PTFE based films. The layers are, preferably, metal-printed with each layer having an ideal thickness of between 0.025 and 0.125 mm. The layers are spaced apart to provide a specified separation (approximately λ/4 at the mid frequency between the two operating bands) using a dielectric material having a dielectric constant lower than 1.2 εᵣ, which exhibits low dielectric losses.

The layers can, alternatively, be etched on thicker substrates, typically based on PFTE substrates loaded with glass or ceramic, up to 0.5 mm thick, although thicker substrates can also be considered for frequencies below 1 GHz. Although this arrangement improves the mechanical robustness of the polarizer screen, it typically limits the bandwidth of each operational band.

Furthermore, the spacer separating the layers can be a composite honeycomb structure whose average dielectric constant and loss is low (typical εᵣ<1.2 and typical tan loss <0.005). The composite materials used are, ideally, selected to improve the mechanical strength of the polarizer screen and also its environmental performance.

FIG. 2 illustrates the metallic artwork provided on a layer of the exemplary polarizer screen shown in FIG. 1. It can be seen that the artwork in this example consists of a grid of parallel metal strips and an array of dipoles interleaved with the strips and periodically repeated. The period of the strips and dipoles are spaced less than one wavelength apart at the highest frequency of operation. At least two dipoles are provided per cell, one arranged to be parallel to the strips, preferably placed in the mid-point between strips, and a second arranged to be perpendicular to the strips. The artworks provided on each layer are, ideally, different to maximize the transmission through the polarizer screen.

FIG. 3 shows another example of metallic artwork provided on a layer. In this example, the perpendicular dipoles are merged with the strips, thereby forming a single structure on the layer.

The dipoles shown in FIGS. 2 and 3 are rectangular. However, they can also be “I”-shaped in order to reduce their size to fit into a required lattice, as shown in the exemplary artwork of the layer shown in FIG. 4.

Any of the above-described arrangements for the polarizer screen can be combined with a conventional polarizer, which converts linearly polarized (LP) waves into the same circular polarization (CP) for both bands, to realize a dual band polarizer that converts a linearly polarized wave into orthogonal linearly polarized waves in each band (i.e. x-direction in band 1 and y-direction in band 2). To achieve this, the conventional polarizer is placed in front of the dual band orthogonal polarizer in such a way that the waves propagate through both structures before reaching free space. The orthogonal polarizations can be aligned at any angle with respect to the direction of polarization of the original incident wave. The conventional polarizer used in the above arrangement is, preferably, a conventional wideband polarizer.

Unlike existing arrangements, the present invention uses periodically arranged metal strips, or elements, which are resonant at a frequency that falls between the lower sub-band and the upper sub-band.

Each of the layers of the structure can therefore be represented as a parallel LC resonator for a certain E-field incidence angle and a series LC resonator for the orthogonal E-field orientation, both equivalent circuit resonators having approximately the same resonant frequency. As in existing polarizer designs, the incident E-field must be at 45° with respect to the rectangular lattice of the metal prints and the components that are parallel to each of the lattice axis suffer a positive phase delay on one of the lattice axes and a negative phase delay on the other lattice axis, as shown in FIG. 5.

Furthermore, a complete dual band antenna system can be created by arranging a polarizer screen of the present invention to cover a linearly polarized radiating aperture. This ensures that any radio waves radiated into free space after propagating through the polarizer screen have an orthogonal circular polarization in each of the two sub-bands, with one of the frequency bands ideally being arranged to receive signals with the other being arranged to transmit signals.

Such an antenna system will normally be used as part of a satellite communications (SATCOM) terminal which also comprises a Low Noise Amplifier (LNA), High Power Amplifier (HPA), up-converters/down-converters, filters and a modem for digital modulation and coding.

The satellite terminal will, ideally, operate a full duplex communication system that will operate in separate bands for transmit and receive. A terminal integrating the present invention will be able to transmit and receive signals in separate bands, with orthogonal circular polarizations matching the satellite signals. For example, this can be achieved using a flat single aperture antenna with a thickness smaller than 25 mm at Ka-Band frequencies.

The integration of the electromagnetic wave polarizer screen with a suitable antenna into a SATCOM terminal will provide significant size, packaging and portability advantages which makes it unique.

In addition, the polarizer screen can be made transparent to a lower frequency band to provide a tri-band antenna system. The polarizer screen can be combined with a radiating aperture which also operates in this low frequency band, without affecting the polarisation purity of the radiated wave. This additional frequency band should be a much lower frequency (typically ten times lower) than the frequency of operation of the polarizer screen. To achieve this, the structure of the polarizer screen and artwork (e.g. metallic strips) can be maintained, except that the grid of strips will be split into sections and connected by built-in planar capacitors, which will exhibit high impedance at the low frequency band.

1. A polarizer screen for a satellite communications terminal, comprising a plurality of layers separated by dielectric material, each layer having a grid of parallel metal strips and a periodic distribution of interleaved metal dipoles, wherein a first set of dipoles is arranged to be perpendicular to the metal strips and a second set of dipoles is arranged to be parallel to the metal strips, wherein an effective resonance frequency of the parallel metal strips and interleaved metal dipoles is approximately the same in a direction parallel to the metal strips and in a direction perpendicular to the metal strips such that linearly polarized electromagnetic waves in different frequency bands either side of the resonance frequency that pass through the screen are converted into orthogonal circular polarization states.

2. The polarizer screen of claim 1, wherein the first set of metal dipoles are arranged to overlap and merge with the metal strips.

3. The polarizer screen of claim 2, wherein each of the metal dipoles form an ‘I’ shape.

4. The polarizer screen of claim 3, wherein the layers comprise polyamide, polyester or PTFE based substrates.

5. The polarizer screen of claim 4, wherein the PTFE based substrates comprise glass or ceramic.

6. The polarizer screen of claim 5, wherein the layers each have a thickness between 0.025 and 0.125 mm.

7. The polarizer screen of claim 6, wherein the dielectric material separating the layers is formed as a composite honeycomb structure.

8. An arrangement of the polarizer screen of claim 1 and a conventional polarizer screen that converts linearly polarized waves into the same hand of circular polarization for both frequency bands, the polarizer screen arranged to be positioned behind the conventional polarizer screen, in use, such that incident electromagnetic waves propagate through the conventional polarizer screen and then the polarizer screen before reaching free space generating a linearly polarized wave at each frequency band, where the linear polarization of one band is orthogonal to the linear polarization generated at the other band.

9. The polarizer screen of claim 8, wherein the conventional polarizer screen comprises a conventional wideband polarizer.

10. A dual band antenna, comprising a single linearly polarized radiating aperture covered by a polarizer screen according to claim 1 and arranged to radiate a single circular polarization in each frequency band where the hand of circular polarization in one of the frequency bands is orthogonal to the polarisation of the other of the frequency bands.

11. A dual band antenna, comprising a single linearly polarized radiating aperture covered by a polarizer screen according to claim 8 and arranged to radiate a single linear polarization in each frequency band where the direction of polarization in one of the frequency bands is orthogonal to the polarisation of the other of the frequency bands.

12. The antenna according to claim 10, further comprising a radiating aperture arranged to radiate at a third separate band of frequency that is sufficiently low that the polarizer screen does not alter the radiated wave.

13. A communications terminal with separate frequency sub-bands for receiving and transmitting circularly polarized radio signals, where the hand of polarization in the each sub-band is orthogonal, the terminal comprising a low noise amplifier and power amplifier connected to a diplexer filter which is connected to a single port of an antenna according to claim 10.

14. A communications terminal with separate frequency sub-bands for receiving and transmitting linearly polarized radio signals, where the direction of polarization in the each sub-band is orthogonal, the terminal comprising a low noise amplifier and power amplifier connected to a diplexer filter which is connected to a single port of an antenna according to claim 11.

15. The communications terminal according to claim 13, further comprising an aperture arranged to radiate a third separate band of frequency that is low relative to the two orthogonally polarized sub-bands.

16. The polarizer screen of claim 2, wherein each of the metal dipoles form an ‘I’ shape.

17. The polarizer screen of claim 16, wherein the layers each have a thickness between 0.025 and 0.125 mm.

18. The polarizer screen of claim 17, wherein the dielectric material separating the layers is formed as a composite honeycomb structure.

19. The antenna according to claim 11, further comprising a radiating aperture arranged to radiate at a third separate band of frequency that is sufficiently low that the polarizer screen does not alter the radiated wave.

20. The communications terminal according to claim 14, further comprising an aperture arranged to radiate a third separate band of frequency that is low relative to the two orthogonally polarized sub-bands.
